(19) United States
(12) Patent Application Publication
(10) Pub. No.: US 2022/0366796 A1
(43) Pub. Date: Nov. 17, 2022

(54) SYSTEMS AND METHODS FOR AIDING GNSS-UNAVAILABLE AIRCRAFT OPERATIONS

(71) Applicant: GE Aviation Systems LLC, Grand Rapids, MI (US)

(72) Inventors: Edward Andrew Lester, Somerville, MA (US); Szabolcs A. Borgyos, Grand Rapids, MI (US)

(73) Assignee: GE Aviation Systems LLC, Grand Rapids, MI (US)

(21) Appl. No.: 17/728,069

(22) Filed: Apr. 25, 2022

Related U.S. Application Data
(60) Provisional application No. 63/188,227, filed on May 13, 2021.

(51) Int. Cl. G08G 5/00; G06T 7/70; G01S 19/48; G01S 19/05

(52) U.S. Cl. CPC G08G 5/0039; G06T 7/70; G01S 19/48; G01S 19/05; G06T 2207/30252; G06T 2207/10032

(57) ABSTRACT

A method includes receiving a flight plan of an aircraft comprising one or more contingency routes, determining a plurality of possible trajectories of the aircraft based on the flight plan and the one or more contingency routes, identifying navigation data associated with one or more locations along each of the possible trajectories, and transmitting the navigation data to the aircraft.

### CROSS-REFERENCE TO RELATED APPLICATION

This application claims priority to U.S. Provisional Application No. 63/188,227 filed on May 13, 2021, the entire contents of which is hereby incorporated by reference.

### FIELD

The present disclosure relates to monitoring of aerial vehicles, and more specifically, to systems and methods for aiding GNSS-unavailable aircraft operations.

### BACKGROUND

Aerial vehicles typically navigate using a Global Navigation Satellite System (GNSS). This may include the use of the Global Positioning System (GPS) or other satellite navigation systems. However, during certain periods of time, GNSS may be unavailable to an aircraft due to weather, environmental obstructions, interference, equipment failure, or other reasons. When GNSS is unavailable, aerial vehicles may rely on other navigation techniques such as inertial navigation or optical flow. While these navigation techniques may be effective for a while, over time they tend to drift and become less accurate unless they are recalibrated. Therefore, there is a need for systems and methods for providing navigation assistance to aerial vehicles when GNSS is unavailable to those aerial vehicles.

### SUMMARY

In an embodiment, a method may include receiving a flight plan of an aircraft including one or more contingency routes, determining a plurality of possible trajectories of the aircraft based on the flight plan and the one or more contingency routes, identifying navigation data associated with one or more locations along each of the possible trajectories, and transmitting the navigation data to the aircraft.

In another embodiment, a navigation assistance unit may include one or more processors, one or more memory modules, and machine readable instructions stored in the one or more memory modules. When executed by the one or more processors, the machine readable instructions may cause the navigation assistance unit to receive a flight plan of an aircraft including one or more contingency routes, determine a plurality of possible trajectories of the aircraft based on the flight plan and the one or more contingency routes, identify navigation data associated with one or more locations along each of the possible trajectories, and transmit the navigation data to the aircraft.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 schematically depicts an exemplary system for providing navigation assistance, according to one or more embodiments shown and described herein;

FIG. 2 schematically depicts an example navigation assistance unit, according to one or more embodiments shown and described herein;

FIG. 3 depicts a flow chart of an illustrative method of providing navigation assistance, according to one or more embodiments shown and described herein;

FIG. 4 depicts a flow chart of another illustrative method of providing navigation assistance, according to one or more embodiments shown and described herein; and

FIG. 5 depicts a flow chart of another illustrative method of providing navigation assistance, according to one or more embodiments shown and described herein.

### DETAILED DESCRIPTION

The present disclosure generally relates to providing navigation assistance to aerial vehicles. Both manned and unmanned aircraft may rely on GNSS (one or more satellite navigation systems that provide autonomous geo-spatial positioning with global or substantially global coverage, e.g., GPS) data for navigation during flights. However, occasionally, GNSS may become unavailable to an aircraft during a flight. This may be due to inclement weather, signal interference, line of sight blockages, equipment failure, and the like. When GNSS becomes unavailable to an aircraft, the aircraft may rely on other forms of navigation. For example, aircraft may utilize dead reckoning techniques using inertial navigation systems or optical flow sensors. These navigation techniques determine a location of an aircraft by starting from a known location of the aircraft and monitoring the change in relative position of the aircraft from the known starting location. For example, an aircraft may determine its location using GPS while GPS is available, and then use inertial navigation to monitor its position with respect to the location determined by GPS when GPS becomes unavailable.

These navigation techniques are a useful way of performing aircraft navigation when GNSS becomes unavailable. However, they are not as accurate as GNSS. As such, the location of an aircraft determined using inertial navigation systems or optical flow sensors tends to drift, over time, from the actual location of the aircraft. Accordingly, the longer these navigation techniques are used, the less accurate they become. To ensure the accuracy of these navigation techniques, they may be periodically recalibrated using the actual location of the aircraft.

Aircraft may store onboard maps to recalibrate the aircraft location using localization techniques such as photo-matching. However, there may be limited storage capacity on the aircraft and a limited amount of map data that can be stored thereon. As such, it may be difficult for an aircraft to rely on map data stored onboard to recalibrate its position, particularly when the aircraft varies its flight path from a planned route.

As such, disclosed herein are systems and methods for assisting an aircraft in determining its location when GNSS is unavailable. The aircraft may then use the determined location to calibrate an inertial navigation system or optical flow sensors as described above. Accordingly, the systems and methods disclosed herein allow aircraft to continue to accurately monitor their position even when GNSS is unavailable.

In embodiments, an off-board network system (e.g., an unmanned traffic management system) may transmit data to an aircraft that the aircraft may use to determine its location. For example, the off-board network system may transmit an image and location of an upcoming scene based on the planned flight path of the aircraft. The aircraft may then utilize photo-matching techniques to identify when it has reached the location of the scene. In other examples, the off-board network system may send other types of data (e.g., radio frequency data) that the aircraft may use to determine its location, as disclosed herein. The aircraft may then calibrate an inertial navigation system or optical flow sensors based on this location. This allows an aircraft to determine its location when GNSS is unavailable without needing to store a large amount of data (e.g., images for photo-matching) on the aircraft.

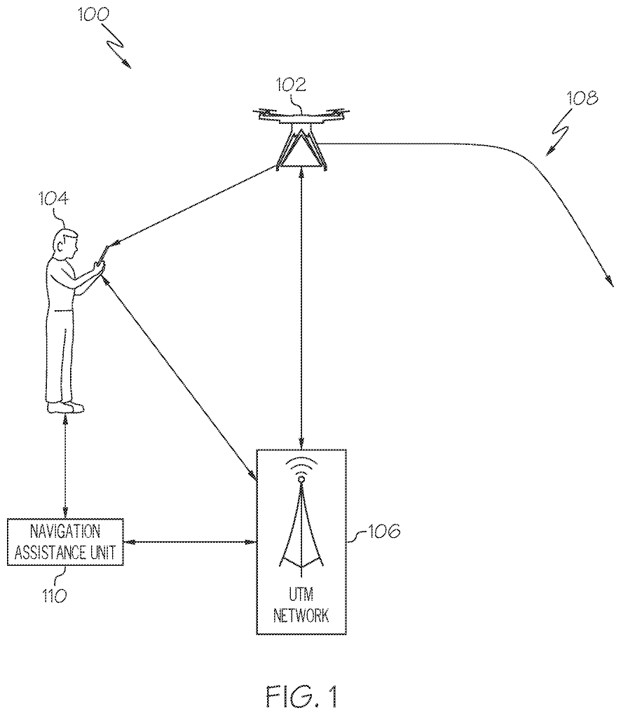

FIG. 1 depicts an example system 100 for aiding GNSS-unavailable aircraft operations. In the example of FIG. 1, an unmanned aircraft system (UAS) 102 is flown in certain airspace along a flight plan or flight path 108. UAS may also be referred to herein as unmanned aerial vehicles (UAV) or drones. While the examples disclosed herein refer to unmanned aircraft, it should be understood that system 100 may also be used with manned aircraft.

In the example of FIG. 1, the UAS 102 may be controlled remotely by a UAS operator 104. The UAS operator 104 may communicate with the UAS 102 via a command and control link (e.g., satellite, radio, cell phone). The UAS operator may transmit commands to control the movement and operation of the UAS 102 and the UAS 102 may transmit commands back to the UAS operator 104 (e.g., telemetry data). In some examples, the UAS 102 may operate partially or completely autonomously.

An unmanned traffic management (UTM) network 106 may manage air traffic involving the UAS 102 and other UAS. The UTM network 106 may comprise one or more UAS service suppliers (US S). A USS may manage UAS traffic within a certain geographic area and/or for a certain set of clients. A USS may monitor UAS with either ground-based radar tracking and/or by receiving telemetry directly from UAS that identifies their position. In addition to tracking the position of UAS, a USS may communicate with UAS operators to provide instructions to guide UAS along certain routes to avoid collision with other UAS and to otherwise manage airspace. In some examples, air traffic may be managed by other ground-based networks.

While a single USS may cover a certain geographic area, a plurality of USS may be part of the UTM network 106 to manage air traffic over a larger geographic area. Different USS that are part of the UTM network 106 may communicate with each other to jointly manage UAS air traffic (e.g., one USS may monitor a particular UAS and hand off control to another USS as the USS is leaving its airspace). UAS operators typically sign up for service with the USS of their choice. As such, multiple USS may provide service to clients in overlapping geographic areas, in which case they may communicate with each other to jointly ensure aircraft separation.

Each USS of the UTM network 106 may monitor one or more UAS operated by one of the clients of the USS using ground-based tracking (e.g., radar) and/or by receiving telemetry information from the UAS themselves. A USS may send commands to the operators of the UAS being monitored to ensure that UAS do not collide with each other and to provide other air traffic control features. In some examples, a USS may send commands directly to UAS to modify their operation (e.g., changing their flight path). In addition, multiple USS in the UTM network 106 may communicate with each other to ensure that UAS being monitored by different USS do not collide with each other. USS may also receive supplemental data from other service providers (e.g., information regarding weather, terrain, and the like) and may provide this information to the USS clients.

A navigation assistance unit 110 may provide navigation assistance as described herein. In particular, the navigation assistance unit 110 may provide navigation assistance to the UAS 102 when GNSS is unavailable to the UAS 102. In the illustrated example, the navigation assistance unit 110 is separate from the UTM network 106. However, in other examples, the navigation assistance unit 110 may be part of the UTM network 106.

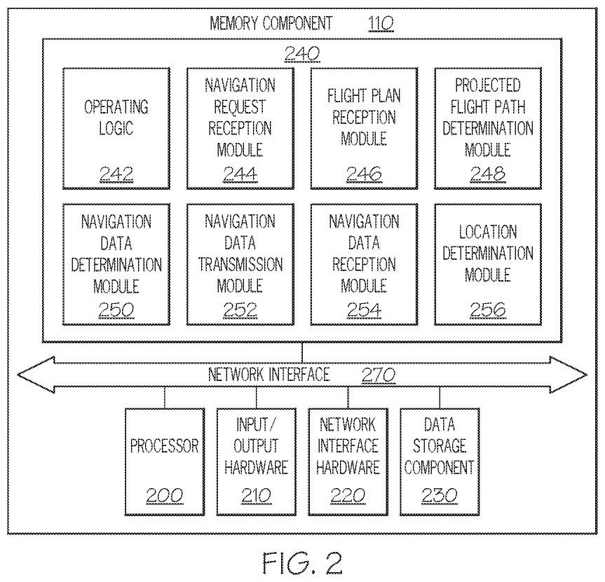

In the illustrated example, the navigation assistance unit 110 is a cloud-based computing device. However, in other examples, the navigation assistance unit 110 may be any type of computing device (e.g., mobile computing device, personal computer, etc.). Additionally, while the navigation assistance unit 110 is depicted in FIGS. 1-2 as a single piece of hardware, this is merely an example. In some examples, the navigation assistance unit 110 may represent a plurality of computers, servers, databases, etc. In some examples, the navigation assistance unit 110 may be configured as a collection of cooperating computing devices or even as a special purpose computer designed specifically for performing the functionality described herein.

Now referring to FIG. 2, the components of the navigation assistance unit 110 are schematically depicted. As illustrated in FIG. 2, the navigation assistance unit 110 may include a processor 200, input/output hardware 210, network interface hardware 220, a data storage component 230, and a non-transitory memory component 240. The memory component 240 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store operating logic 242, a navigation request reception module 244, a flight plan reception module 246, a projected flight path determination module 248, a navigation data determination module 250, a navigation data transmission module 252, a navigation data reception module 254, and a location determination module 256 (each of which may be embodied as a computer program, firmware, or hardware, as an example). A network interface 270 is also included in FIG. 2 and may be implemented as a bus or other interface to facilitate communication among the components of the navigation assistance unit 110.

The processor 200 may include any processing component configured to receive and execute instructions (such as from the data storage component 230 and/or the memory component 240). The input/output hardware 210 may include a monitor, keyboard, mouse, printer, camera, microphone, speaker, touchscreen, and/or other device for receiving from, and sending data to the navigation assistance unit 110. The network interface hardware 220 may include any wired or wireless networking hardware, such as a modem, LAN port, wireless fidelity (Wi-Fi) card, WiMax card, mobile communications hardware, and/or other hardware for communicating with the UTM network 106, and other networks and/or devices.

The data storage component 230 may store information received from the UAS 102, the UAS operator 104 and/or the UTM network 106. The data received from these devices or systems is discussed in further detail below. The data storage component 230 may also store navigation data, including geo-referenced mapping data, as described herein.

Included in the memory component 240 are operating logic 242, the navigation request reception module 244, the flight plan reception module 246, the projected flight path determination module 248, the navigation data determination module 250, the navigation data transmission module 252, the navigation data reception module 254, and the location determination module 256. The operating logic 242 may include an operating system and/or other software for managing components of the navigation assistance unit 110.

The navigation request reception module 244 may receive a request from the UAS 102 or from the UAS operator 104 for navigation assistance. In some examples, the UAS operator 104 may transmit a request to the navigation assistance unit 110 when navigation assistance is desired (e.g., when GNSS is unavailable to the UAS 102). In other examples, the UAS 102 may automatically transmit a request to the navigation assistance unit 110 when GNSS is unavailable (e.g., when the UAS 102 loses a GPS signal). In either example, the request for navigation assistance may be received by the navigation request reception module 244.

In the illustrated example, the navigation assistance unit 110 provides navigation assistance to the UAS 102 after receiving a request for navigation assistance, as disclosed herein. However, in other examples, the navigation assistance unit 110 may continually transmit data to the UAS 102 to provide navigation assistance (e.g., at periodic intervals). This may allow navigation assistance to be provided to the UAS 102 in situations where GNSS is unavailable and the UAS 102 or the UAS operator 104 is unable to transmit a request for navigation assistance to the navigation assistance unit 110. In these examples, the navigation assistance unit 110 may not include the navigation request reception module 244.

The flight plan reception module 246 may receive a flight plan for the UAS 102. In order to provide navigation assistance to the UAS 102, the navigation assistance unit 110 may transmit data to the UAS 102 associated with a location that the UAS 102 is approaching. For example, the navigation assistance unit 110 may transmit a geo-referenced image of an area that the UAS 102 is approaching (e.g., an image of an area with associated location information). Then, when the UAS 102 reaches a position where sensor data matches the data received from the navigation assistance unit 110 (e.g., when an image captured by the UAS 102 matches the image received by the navigation assistance unit 110), the UAS 102 may determine that its location is equal to the location associated with the data received from the navigation assistance unit 110 (e.g., the location of the transmitted image). Therefore, in order for the navigation assistance unit 110 to provide the appropriate data to the UAS 102, the navigation assistance unit 110 must determine the flight path of the UAS 102.

In embodiments, the navigation assistance unit 110 may determine the flight path of the UAS 102 based on a flight plan of the UAS 102, which may be received by the flight plan reception module 246. In the illustrated example, the flight plan of the UAS 102 is stored with the UTM network 106 prior to a flight and the flight plan reception module 246 receives the flight plan of the UAS 102 from the UTM network 106. In other examples, the flight plan reception module 246 may receive the flight plan of the UAS 102 directly from the UAS 102 or from the UAS operator 104. In some examples, when the UAS 102 transmits a request for navigation assistance, the UAS 102 also transmits its planned flight path, which may be received by the flight plan reception module 246.

In embodiments, the flight plan received by the flight plan reception module 246 includes the planned trajectory of the UAS 102. In some examples, the flight plan received by the flight plan reception module 246 may also contain contingency routes. These may include potential trajectories of the UAS 102 based on certain contingencies (e.g., if the UAS 102 needs to change its path due to weather, governmental airspace restrictions, conflicts with other aircraft, and the like). The planned trajectory and contingency routes of the UAS 102 may be utilized by the navigation assistance unit 110 to determine potential trajectories of the UAS 102, as disclosed in further detail below.

The projected flight path determination module 248 may determine one or more possible projected flight paths of the UAS 102. As explained above, the flight plan reception module 246 may receive a flight plan of the UAS 102, which may include a planned trajectory of the UAS 102 as well as one or more contingency routes. Accordingly, the projected flight path determination module 248 may determine one or more possible projected flight paths or trajectories of the UAS 102 based on the flight plan received by the flight plan reception module 246. As explained above, the navigation assistance unit 110 may provide navigation assistance by sending data associated with a location that the UAS 102 is approaching. Accordingly, the projected flight path determination module 248 may identify a location or possible locations that the UAS 102 is approaching.

The projected flight path determination module 248 may identify the planned trajectory of the UAS 102, based on the flight plan received by the flight plan reception module 246, as one possible flight path of the UAS 102. The projected flight path determination module 248 may also identify one or more contingency routes included in the flight plan received by the flight plan reception module 246 as additional possible flights paths of the UAS 102. In some examples, the projected flight path determination module 248 may also determine possible flight paths of the UAS 102 based on known obstacles such as weather systems or airspace restrictions zones. For example, the navigation assistance unit 110 may receive data from the UTM network 106 indicating that the UAS 102 is approaching a thunderstorm or other dangerous weather system that the UAS 102 must navigate around. Accordingly, the projected flight path determination module 248 may determine a possible flight path for the UAS 102 that travels around the weather system. In some examples, the projected flight path determination module 248 may determine a possible flight path for the UAS 102 based on expected navigation performance of the vehicle.

The navigation data determination module 250 may identify navigation data to be transmitted to the UAS 102. The navigation data identified by the navigation data determination module 250 may comprise data that the UAS 102 may use to determine its location when GNSS is unavailable to the UAS 102. In one example, the navigation data identified by the navigation data determination module 250 may include a geo-referenced image of a location that the UAS 102 is approaching (e.g., an image of an area with associated location information). In this example, the navigation assistance unit 110 may transmit this image along with the location of the image to the UAS 102, as further described below. Once the UAS 102 receives the image, the UAS 102 may capture images of its surroundings (e.g., with an onboard camera) and compare the captured images to the received image using photo-matching techniques. When an image captured by the UAS 102 matches the image received from the navigation assistance unit 110, the UAS 102 may determine that its location is the equal to the location of the received image.

In some examples, the navigation data determination module 250 may identify particular images to send to the UAS 102 based on the altitude of the UAS 102. For example, at higher altitudes, lower resolution images may be sufficient for the UAS 102 to determine its location using photo-matching techniques. However, at lower altitudes, higher resolution images may be needed for the UAS 102 to identify its position using photo-matching techniques. Accordingly, when the UAS 102 is at a higher altitude, the navigation data determination module 250 may identify lower resolution images to send to the UAS 102, thereby reducing the bandwidth of transmission.

In another example, the navigation data identified by the navigation data determination module 250 may comprise visual alignment points or landmark data. This visual alignment data may include locations of landmarks that the UAS 102 may identify such as road intersections, unique buildings, or other structures.

In some examples, the navigation data identified by the navigation data determination module 250 may comprise features extracted from images. That is, the navigation data determination module 250 may process one or more images and perform feature extraction to extract features from the image. The extracted features may then comprise the navigation data that is transmitted to the UAS 102, rather than the images themselves. This may reduce the amount of data being transmitted, thereby reducing transmission bandwidth.

In another example, the navigation data identified by the navigation data determination module 250 may comprise navigational reference points such as emitter locations of a plurality of radio frequency (RF) signals (e.g., television and/or radio towers, WiFi beacons, cell towers, and the like). When the UAS 102 receives this navigation data, the UAS 102 may determine its location based on the received navigational reference points. For example, if the UAS 102 receives emitter locations of RF signals, the UAS 102 may then detect RF signals using onboard sensors. The UAS 102 may then use triangulation to determine its location based on the detected RF signals and the received emitter locations of RF signals.

In another example, the navigation data identified by the navigation data determination module 250 may comprise terrain data. When the UAS 102 receives this navigation data, the UAS 102 may use onboard sensors to monitor the terrain that it flies over. The UAS 102 may then determine its location by comparing the detected terrain to the terrain data received from the navigation assistance unit 110 by using terrain relative navigation techniques. In some examples, the navigation data identified by the navigation data determination module 250 may comprise a combination of images, extracted features, visual alignment points, terrain data, and navigational reference points.

The navigation data determination module 250 may identify navigation data based on the one or more possible flight paths determined by the projected flight path determination module 248. That is, the navigation data determination module 250 may identify navigation data associated with each possible flight path of the UAS 102. In some examples, the navigation data determination module 250 may identify navigation data associated with one location along each possible flight path of the UAS 102. For example, the navigation data determination module 250 may identify an image of one location along each possible flight path of the UAS 102. In other examples, the navigation data determination module 250 may identify navigation data associated with multiple locations along each possible flight path of the UAS 102. For example, the navigation data determination module 250 may identify images of multiple locations along each possible flight path of the UAS 102. By identifying navigation data associated with multiple locations along each possible flight path of the UAS 102, the UAS 102 may be more likely to localize to at least one of the locations. For example, if the UAS 102 is unable to perform photo-matching to a received image of one location along its flight path (e.g., due to image obstruction or equipment failure), the UAS 102 may still be able to perform photo-matching to another received image of a different location along its flight path. Thus, the chances of the UAS 102 being able to determine its location may be increased.

In the illustrated example, the data storage component 230 of the navigation assistance unit 110 stores navigation data that may be identified by the navigation data determination module 250. In some examples, the navigation assistance unit 110 may receive navigation data from UAS and may be store the received data in the data storage component 230, as discussed in further detail below. In some examples, the navigation data determination module 250 may get navigation data from a remote computing device (e.g., the UTM network 106 or a map server). When identifying navigation data to transmit to the UAS 102, the navigation data determination module 250 may consider what navigation data is available in the data storage component 230 and/or remote computing devices. The navigation data determination module 250 may also consider what data is already onboard the UAS 102 when identifying navigation data to transmit to the UAS 102.

In some examples, the navigation data determination module 250 may identify navigation data associated with a location along a possible flight path of the UAS 102 that is a certain distance from current location of the UAS 102. In some examples, the navigation data determination module 250 may identify navigation data associated with a location along a possible flight path of the UAS 102 that the UAS 102 is expected to reach in a certain time. This may be based on the current location of the UAS 102 and the speed of the UAS 102.

The navigation data transmission module 252 may transmit the navigation data identified by the navigation data determination module 250 to the UAS 102. The navigation data transmission module 252 may also transmit a location associated with the navigation data (e.g., latitude and longitude of a location captured by an image). As discussed above, the navigation data transmitted by the navigation data transmission module 252 may include one or more images, navigational reference points such as locations of RF emissions, terrain data, or other data that may be used by the UAS 102 to determine its location.

In some examples, the navigation data transmission module 252 may transmit navigation data to the UAS 102 after the navigation request reception module 244 receives a request for navigation data from the UAS 102. In some examples, the navigation data transmission module 252 may continually transmit navigation data to the UAS 102 at periodic intervals.

In some examples, the navigation data transmission module 252 may transmit navigation data to the UAS 102 when the navigation assistance unit 110 or the UTM network 106 determines that the UAS 102 is approaching a location where GNSS is likely to be unavailable (e.g., the UAS 102 may be approaching an area where GPS is unavailable due to interference or line-of-sight blockage). In some examples, when the UTM network 106 determines that UAS 102 is approaching a location where GNSS is likely to be unavailable, the UTM network 106 may transmit, to the navigation assistance unit 110, a request for navigation data to be transmitted to the UAS 102.

The navigation data reception module 254 may receive navigation data from one or more UAS. In some examples, UAS that are in flight may collect data such as image data, RF data, or terrain data using onboard sensors and the UAS may transmit the collected data to the navigation assistance unit 110. This data may be received by the navigation data reception module 254 and may be stored in the data storage component 230. The data may then be used by the navigation assistance unit 110 as navigation data, using the techniques described above.

By collecting data from UAS during UAS flights, the navigation assistance unit 110 may continually increase its database of available navigation data. Thus, when the navigation assistance unit 110 provides navigation assistance to a UAS, the navigation data determination module 250 may have more navigation data to choose from. Accordingly, it may be more likely that the navigation data determination module 250 is able to select navigation data that the UAS being provided assistance can use to accurately determine its location.

The location determination module 256 may receive data from the UAS 102 and may determine the location of the UAS 102, as disclosed herein. In the examples described above, the navigation assistance unit 110 transmits navigation data to the UAS 102 and after receiving the navigation data, the UAS 102 utilizes the received data to determine its location. For example, the UAS 102 may capture sensor data and may perform photo-matching, triangulation of RF signals, or terrain relative navigation to determine its location based on the received navigation data and the data captured by the vehicle sensors. However, these techniques may require substantial computing resources, which may be limited on a UAS. Accordingly, it may be desirable to utilize the computing resources of the navigation assistance unit 110 to perform these techniques to determine the location of the UAS 102, thereby reducing the computing resources needed to be utilized by the UAS 102.

Accordingly, in some examples, the UAS 102 may capture sensor data and may transmit the captured sensor data to the navigation assistance unit 110. This data may be received by the location determination module 256, which may utilize the techniques described above to determine the location of the UAS 102. For example, the UAS 102 may capture an image using an onboard camera and may transmit the image to the navigation assistance unit 110. The location determination module 256 may then perform photo-matching against images selected by the navigation data determination module 250 to determine the location of the UAS 102.

In some examples, the UAS 102 may continually capture images at periodic intervals and transmit the captured images to the navigation assistance unit 110. The location determination module 256 may then perform photo-matching between each received image and the one or more images selected by the navigation data determination module 250 until a match is found. The location determination module 256 may then determine that the location of the UAS 102 is equal to the location of the matching image selected by the navigation data determination module 250.

In other examples, the location determination module 256 may receive RF data captured by the UAS 102 and may perform RF triangulation based on the received RF data and RF data selected by the navigation data determination module 250 to determine the location of the UAS 102. In other examples, the location determination module 256 may receive terrain data captured by the UAS 102 and may perform terrain relative navigation based on the received terrain data and the terrain data selected by the navigation data determination module 250. Once the location determination module 256 determines the location of the UAS 102, the location determination module 256 may transmit the determined location to the UAS 102.

In some examples, both the UAS 102 and the location determination module 256 may determine the location of the UAS 102. That is, the UAS 102 may use the techniques described above to determine its location based on sensor data captured by the UAS 102 and navigation data received from the navigation assistance unit 110. The UAS 102 may then transmit the determined location and the data used to determine its location to the navigation assistance unit 110 and the location determination module 256 may independently determine the location of the UAS 102 to confirm the determination made by the UAS 102 itself. The location determination module 256 may then transmit the location of the UAS 102 that it independently determined to confirm the location determined by the UAS 102, thereby providing redundancy. In other examples, the location determination module 256 may only transmit correction data to the location determined by the UAS 102, thereby reducing the amount of data to be transmitted. Alternatively, the location determination module 256 may transmit an alert if the location determined by the UAS 102 is not confirmed to be accurate.

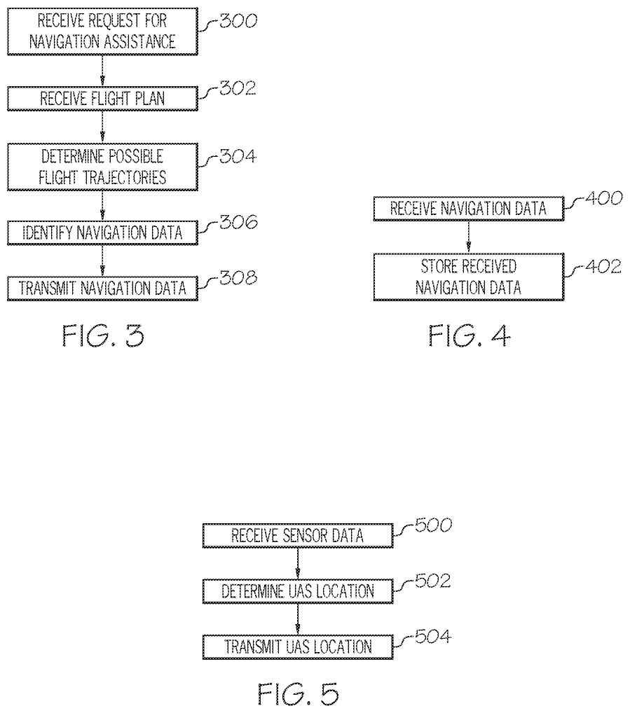

Referring now to FIG. 3, a flow chart is shown of an example method of operating the navigation assistance unit 110, according to one or more embodiments shown and described herein. In particular, FIG. 3 shows an example method of providing navigation assistance to the UAS 102 in the example of FIG. 1.

At step 300, the navigation request reception module 244 receives a request for navigation assistance from the UAS 102. In some examples, the navigation request reception module 244 may receive a request for navigation assistance from the UAS operator 104 rather than from the UAS 102. In other examples, the navigation request reception module 244 may receiver a request for navigation assistance from a pilot of a manned aircraft. In embodiments, the UAS 102 or the UAS operator 104 may transmit a request for navigation assistance to the navigation assistance unit 110 when GNSS is unavailable to the UAS 102. In some examples, the UTM network 106 may transmit a request to the navigation assistance unit 110 for navigation assistance on behalf of the UAS 102 when the UTM network 106 detects that GNSS is unavailable to the UAS 102 or is likely to be unavailable to the UAS 102 in the near future. In some examples, the navigation assistance unit 110 may continually transmit navigation assistance to the UAS 102 without receiving a request for navigation assistance. In these examples, step 300 of FIG. 3 may be eliminated.

At step 302, the flight plan reception module 246 receives a flight plan for the UAS 102. In some examples, the flight plan reception module 246 may receive the flight plan from the UTM network 106. In other examples, the flight plan reception module 246 may receive the flight plan directly from the UAS 102. In embodiments, the flight plan received by the flight plan reception module 246 may include a planned trajectory for the UAS 102. In some examples, the flight plan received by the flight plan reception module 246 may determine possible contingency routes for the UAS 102 (e.g., alternative possible trajectories).

At step 304, the projected flight path determination module 248 determines possible flight trajectories of the UAS 102. In embodiments, the projected flight path determination module 248 may determine possible flight trajectories of the UAS 102 based on the flight plan received by the flight plan reception module 246. One possible flight trajectory of the UAS 102 determined by the projected flight path determination module 248 may be based on the planned flight trajectory of the UAS 102, according to the received flight plan. Other possible flight trajectories of the UAS 102 determined by the projected flight path determination module 248 may be based on contingency routes contained in the received plan. In some examples, the projected flight path determination module 248 may determine possible flight trajectories of the UAS 102 based on known conflicts in the path of the UAS 102 (e.g., inclement weather or airspace exclusion zones).

At step 306, the navigation data determination module 250 identifies navigation data that the UAS 102 may utilize to determine its location. In embodiments, the navigation data determination module 250 may identify navigation data for each possible flight trajectory of the UAS 102 determined by the projected flight path determination module 248. In particular, the navigation data determination module 250 may identify navigation data associated with at least one location along each possible flight trajectory of the UAS 102 determined by the projected flight path determination module 248. In some examples, the navigation data may comprise an image associated with a particular location. In other examples, the navigation data may comprise RF emission locations around a particular location. In other examples, the navigation data may comprise terrain data associated with a particular location. In other examples, the navigation data may comprise other types of data associated with a particular location or a combination of different types of data associated with a particular location.

At step 308, the navigation data transmission module 252 transmits the navigation data identified by the navigation data determination module 250 to the UAS 102. In some examples, the navigation data transmission module 252 may transmit the identified navigation data to the UAS operator 104. When the navigation data is received by the UAS 102, the UAS 102 may utilize the received navigation data to identify its location using the techniques described above (e.g., photo-matching, RF triangulation, terrain relative navigation).

In some examples, the steps of the method of FIG. 3 are performed a single time upon reception of a request for navigation assistance. In some examples, the steps of the method of FIG. 3 may be repeated periodically upon reception of a request for navigation assistance. That is, the navigation assistance unit 110 may continually identify updated navigation data as the location of the UAS 102 changes (e.g., at periodic intervals) and may continually transmit the navigation data to the UAS 102. This may increase the likelihood that the UAS 102 is able to utilize the received navigation data to determine its position. In some examples, the frequency at which the navigation assistance unit 110 transmits navigation data to the UAS 102 may be based on the speed that the UAS 102 is traveling. That is, as the UAS 102 travels at a higher speed, more data may be needed for the UAS 102 to determine its position.

Referring now to FIG. 4, a flow chart is shown of another example method of operating the navigation assistance unit 110, according to one or more embodiments shown and described herein. In particular, FIG. 4 shows an example method of receiving data from one or more UAS that the navigation assistance unit 110 may use to provide navigation assistance to other UAS.

At step 400, the navigation data reception module 254 receives data from one or more UAS. The data received by the navigation data reception module 254 may comprise image data, RF data, terrain data, or other data captured by onboard sensors of one or more UAS. The data received by the navigation data reception module 254 may be used as navigation data when providing navigation assistance as described above with respect to the method of FIG. 3.

At step 402, the navigation data reception module 254 stores the received data in the data storage component 230. Accordingly, the navigation available to the navigation assistance unit 110 may be increased over time as more navigation data is received from UAS during flight operations. By continually receiving data, the navigation assistance unit 110 may also have access to more recent data.

Referring now to FIG. 5, a flow chart is shown of another example method of operating the navigation assistance unit 110, according to one or more embodiments shown and described herein. In particular, FIG. 5 shows an example method of determining a location of the UAS 102, in the example of FIG. 1. The method of FIG. 5 may be performed by the navigation assistance unit 110 to determine the location of the UAS 102 using the techniques described herein rather than the UAS 102 determining its location, thereby reducing the amount of computing resources used by the UAS 102.

At step 500, the location determination module 256 receives sensor data captured by the UAS 102. The received sensor data may comprise image data, RF data, terrain data, or other types of data. In some examples, the location determination module 256 may also receive an estimated location of the UAS 102 as determined by the UAS 102 itself.

At step 502, the location determination module 256 determines the location of the UAS 102 based on the received sensor data and navigation data identified by the navigation data determination module 250 using the techniques described above. For example, the location determination module 256 may determine the location of the UAS 102 by performing photo-matching, RF triangulation, or terrain relative navigation.

At step 504, the location determination module 256 transmits the determined location to the UAS 102. In examples where the location determination module 256 receives an estimated location determined by the UAS 102, the location determination module 256 may transmit a confirmation that the location determined by the UAS 102 was correct, or correction information to the location determined by the UAS 102 if it was not correct, in addition to or instead of transmitting the location determined by the location determination module 256.

It should now be understood that the devices, systems, and methods described herein provide for aiding GNSS-unavailable aircraft operations. When an aircraft loses access to GNSS during a flight operation, the aircraft may transmit a request for navigation assistance to a navigation assistance unit. The navigation assistance unit may receive the request for navigation assistance and may also receive a flight plan of the aircraft. The flight plan of the aircraft may include a planned trajectory of the aircraft and contingency routes for the aircraft.

The navigation assistance unit may then determine possible trajectories of the aircraft based on the received flight plan. The navigation assistance unit may identify navigation data that the aircraft may use to determine its location. The navigation data may be associated with upcoming locations along the possible trajectories of the aircraft. The navigation data may include images, RF emission locations, terrain data, or other types of navigation data. The navigation assistance unit may then transmit the identified navigation data to the aircraft. The aircraft may then determine its location based on the received navigation data using techniques such as photo-matching, RF triangulation, or terrain relative navigation.

In some examples, the navigation assistance unit may build up a database of navigation data by receiving sensor data from one or more aircraft during flight operations. In some examples, aircraft may transmit sensor data to the navigation assistance unit and the navigation assistance unit may determine the location of the aircraft based on the received sensor data and navigation data. For example, the navigation assistance unit may perform photo-matching, RF triangulation, or transmission relative navigation techniques. After determining the location of the aircraft, the navigation assistance unit may transmit the determined location to the aircraft.

The disclosed navigation assistance unit may allow aircraft to determine their location during flight operations when GNSS is unavailable. By storing navigation data on the navigation assistance unit, when navigation assistance is needed for an aircraft, the navigation assistance unit may transmit only relevant data to the aircraft. This may reduce the data storage needed by the aircraft. Once an aircraft determines its location using navigation data received from the navigation assistance unit, the aircraft may use the determined location to calibrate an inertial navigation system or optical flow sensors. In some examples, the determination of the location of the aircraft may be performed by the navigation assistance unit rather than the aircraft, thereby reducing the amount of computing resources needed on the aircraft.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Further aspects of the invention are provided by the subject matter of the following clauses.

A method comprising receiving a flight plan of an aircraft comprising one or more contingency routes; determining a plurality of possible trajectories of the aircraft based on the flight plan and the one or more contingency routes; identifying navigation data associated with one or more locations along each of the possible trajectories; and transmitting the navigation data to the aircraft.

The method of any preceding clause, wherein the navigation data comprises images associated with the one or more locations.

The method of any preceding clause, wherein the navigation data comprises one or more radio frequency emission locations around the one or more locations.

The method of any preceding clause, wherein the navigation data comprises terrain data associated with the one or more locations.

The method of any preceding clause, further comprising determining when GNSS will be unavailable to the aircraft; determining one or more estimated locations of the aircraft when GNSS will be unavailable to the aircraft; and identifying navigation data associated with at least one of the one or more estimated locations of the aircraft when GNSS will be unavailable to the aircraft.

The method of any preceding clause, further comprising receiving the flight plan from a ground-based network.

The method of any preceding clause, further comprising identifying updated navigation data at periodic intervals; and transmitting the updated navigation data to the aircraft at periodic intervals.

The method of any preceding clause, further comprising receiving sensor data gathered by one or more aircraft; and storing the sensor data as navigation data.

The method of any preceding clause, further comprising receiving sensor data from the aircraft; determining a location of the aircraft based on the sensor data and the navigation data; and transmitting the location to the aircraft.

The method of any preceding clause, further comprising determining the location of the aircraft using photo-matching techniques.

The method of any preceding clause, further comprising determining the location of the aircraft using RF triangulation techniques.

The method of any preceding clause, further comprising determining the location of the aircraft using terrain relative navigation techniques.

A navigation assistance unit comprising one or more processors; one or more memory modules; and machine readable instructions stored in the one or more memory modules that, when executed by the one or more processors, cause the navigation assistance unit to receive a flight plan of an aircraft comprising one or more contingency routes; determine a plurality of possible trajectories of the aircraft based on the flight plan and the one or more contingency routes; identify navigation data associated with one or more locations along each of the possible trajectories; and transmit the navigation data to the aircraft.

The navigation assistance unit of any preceding clause wherein the navigation data comprises images associated with the one or more locations.

The navigation assistance unit of any preceding clause, wherein the navigation data comprises one or more radio frequency emission locations around the one or more locations.

The navigation assistance unit of any preceding clause, wherein the navigation data comprises terrain data associated with the one or more locations.

The navigation assistance unit of any preceding clause, wherein the instructions further cause the navigation assistance unit to determine when GNSS will be unavailable to the aircraft; determine one or more estimated locations of the aircraft when GNSS will be unavailable to the aircraft; and identify navigation data associated with the at least one of the one or more estimated locations of the aircraft when GNSS will be unavailable to the aircraft.

The navigation assistance unit of any preceding clause, wherein the instructions further cause the navigation assistance unit to identify updated navigation data at periodic intervals; and transmit the updated navigation data to the aircraft at periodic intervals.

The navigation assistance unit of any preceding clause, wherein the instructions further cause the navigation assistance unit to receive sensor data gathered by one or more aircraft; and store the sensor data as navigation data.

The navigation assistance unit of any preceding clause, wherein the instructions further cause the navigation assistance unit to receive sensor data from the aircraft; determine a location of the aircraft based on the sensor data and the navigation data; and transmit the location to the aircraft.

What is claimed is:

1. A method comprising:
receiving a flight plan of an aircraft comprising one or more contingency routes;
determining a plurality of possible trajectories of the aircraft based on the flight plan and the one or more contingency routes;
identifying navigation data associated with one or more locations along each of the possible trajectories; and
transmitting the navigation data to the aircraft.

2. The method of claim 1, wherein the navigation data comprises images associated with the one or more locations.

3. The method of claim 1, wherein the navigation data comprises one or more radio frequency emission locations around the one or more locations.

4. The method of claim 1, wherein the navigation data comprises terrain data associated with the one or more locations.

5. The method of claim 1, further comprising:
determining when GNSS will be unavailable to the aircraft;
determining one or more estimated locations of the aircraft when GNSS will be unavailable to the aircraft; and
identifying navigation data associated with at least one of the one or more estimated locations of the aircraft when GNSS will be unavailable to the aircraft.

6. The method of claim 1, further comprising receiving the flight plan from a ground-based network.

7. The method of claim 1, further comprising:
identifying updated navigation data at periodic intervals; and
transmitting the updated navigation data to the aircraft at periodic intervals.

8. The method of claim 1, further comprising:
receiving sensor data gathered by one or more aircraft; and
storing the sensor data as navigation data.

9. The method of claim 1, further comprising:
receiving sensor data from the aircraft;
determining a location of the aircraft based on the sensor data and the navigation data; and
transmitting the location to the aircraft.

10. The method of claim 9, further comprising determining the location of the aircraft using photo-matching techniques.

11. The method of claim 9, further comprising determining the location of the aircraft using RF triangulation techniques.

12. The method of claim 9, further comprising determining the location of the aircraft using terrain relative navigation techniques.

13. A navigation assistance unit, comprising:
one or more processors;
one or more memory modules; and
machine readable instructions stored in the one or more memory modules that, when executed by the one or more processors, cause the navigation assistance unit to:
receive a flight plan of an aircraft comprising one or more contingency routes;
determine a plurality of possible trajectories of the aircraft based on the flight plan and the one or more contingency routes;
identify navigation data associated with one or more locations along each of the possible trajectories; and
transmit the navigation data to the aircraft.

14. The navigation assistance unit of claim 13, wherein the navigation data comprises images associated with the one or more locations.

15. The navigation assistance unit of claim 13, wherein the navigation data comprises one or more radio frequency emission locations around the one or more locations.

16. The navigation assistance unit of claim 13, wherein the navigation data comprises terrain data associated with the one or more locations.

17. The navigation assistance unit of claim 13, wherein the instructions further cause the navigation assistance unit to:
determine when GNSS will be unavailable to the aircraft;
determine one or more estimated locations of the aircraft when GNSS will be unavailable to the aircraft; and
identify navigation data associated with the at least one of the one or more estimated locations of the aircraft when GNSS will be unavailable to the aircraft.

18. The navigation assistance unit of claim 13, wherein the instructions further cause the navigation assistance unit to:
identify updated navigation data at periodic intervals; and
transmit the updated navigation data to the aircraft at periodic intervals.

19. The navigation assistance unit of claim 13, wherein the instructions further cause the navigation assistance unit to:
receive sensor data gathered by one or more aircraft; and
store the sensor data as navigation data.

20. The navigation assistance unit of claim 13, wherein the instructions further cause the navigation assistance unit to:
receive sensor data from the aircraft;
determine a location of the aircraft based on the sensor data and the navigation data; and
transmit the location to the aircraft.
